(19) United States
(12) Patent Application Publication
(10) Pub. No.: US 2013/0073548 A1
(43) Pub. Date: Mar. 21, 2013

(54) PRODUCT ATTRIBUTE ENFORCEMENT RULES

(71) Applicants: William Loebertmann, Shakopee, MN (US); Ken Hoffman, Eagan, MN (US)

(72) Inventors: William Loebertmann, Shakopee, MN (US); Ken Hoffman, Eagan, MN (US)

(21) Appl. No.: 13/236,796

(22) Filed: Sep. 20, 2011

(51) Int. Cl. G06F 17/30

(52) U.S. Cl. 707/736; 707/E17.005

(57) ABSTRACT

Rules may be defined and enforced against air waybills in a logistics management system (LMS) to reduce operator input error and reduce operator input omissions. A rule may include a product code, a restriction type, and special handling codes associated with the product code by the restriction type. For example, when an air waybill has a particular product type, a rule may require certain special handling codes be applied to the air waybill. In another example, when an air waybill has a particular product type, a rule may prevent certain special handling codes from being applied to the air waybill.

### TECHNICAL FIELD

The instant disclosure relates to databases. More specifically, the instant disclosure relates to database management systems.

### BACKGROUND

Logistics management systems (LMS) provide computing resources to process freight shipment data, and attempt to aid in scheduling, coordinating and tracking various aspects of the freight shipment. LMSs often involve entry of a large amount of data by relatively untrained individuals. Thus, data may be entered incorrectly by a user, or a user may omit to enter certain data. Additionally, users may not be able to effectively manually check data entry because the large number of parties involved in freight shipments may have different rules. For example, some carriers may require certain data or other carrier may require certain handling procedures.

### SUMMARY

According to one embodiment, a method includes receiving a product code. The method also includes receiving a restriction type. The method further includes receiving at least one special handling code. The method also includes associating the at least one special handling code with the product code according to the restriction type to create a rule.

According to another embodiment, a computer program product includes a non-transitory computer readable medium having code to receive a product code. The medium also includes code to receive a restriction type. The medium further includes code to receive at least one special handling code. The medium also includes code to associate the at least one special handling code with the product code according to the restriction type to create a rule.

According to yet another embodiment, a system includes a memory and at least one processor coupled to the memory. The processor is configured to receive a product code. The processor is also configured to receive a restriction type. The processor is further configured to receive at least one special handling code. The processor is also configured to associate the at least one special handling code with the product code according to the restriction type to create a rule.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method of creating rules for product codes according to one embodiment of the disclosure.

FIG. 2 is a flow chart illustrating a method of enforcing rules for product codes according to one embodiment of the disclosure.

FIG. 3 is a block diagram illustrating rules for product codes according to one embodiment of the disclosure.

FIG. 4 is a block diagram illustrating creating rules for product codes according to one embodiment of the disclosure.

FIG. 5 is block diagram illustrating a data management system configured to store databases, tables, and/or records according to one embodiment of the disclosure.

FIG. 6 is a block diagram illustrating a data storage system according to one embodiment of the disclosure.

FIG. 7 is a block diagram illustrating a computer system according to one embodiment of the disclosure.

### DETAILED DESCRIPTION

Data entry into logistics management systems (LMS) may be improved in accuracy and omissions reduced by implementing rules for enforcement against data, such as air waybills. For example, when an air waybill for a certain product type is entered, the LMS may require certain special handling codes for handling shipments of the certain product type.

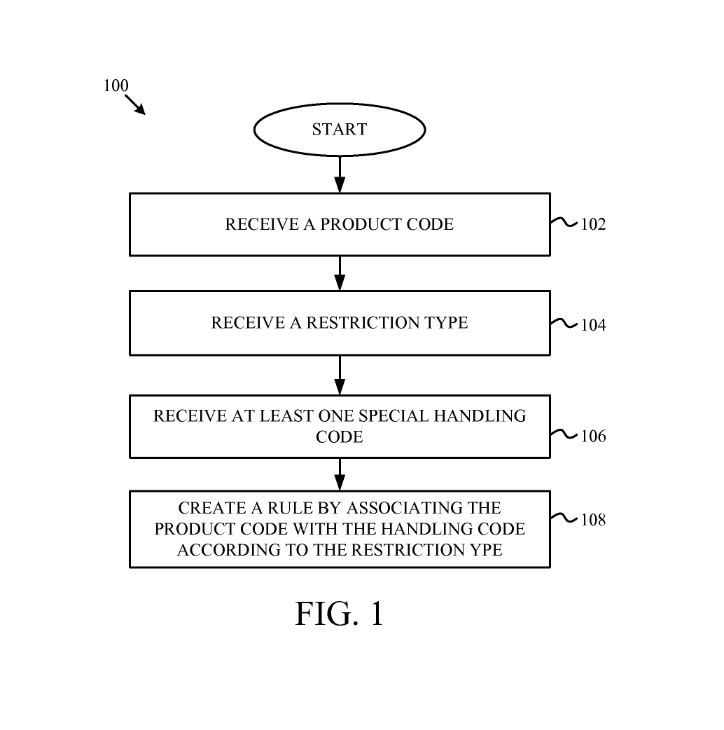

FIG. 1 is a flow chart illustrating a method of creating rules for product codes according to one embodiment of the disclosure. A method 100 begins at block 102 with receiving a product code. A product code may be an abbreviation or code for a particular product or group of products. The method 100 continue to block 104 with receiving a restriction type. The restriction type may define how the product code interacts with special handling codes. For example, the restriction type may specify that a product code may only be used with certain special handling codes. In another example, the restriction type may specify that a product code may not be used with certain special handling codes. At block 106 at least one special handling code is received. A special handling code may be an abbreviation or code for handling of a package. For example, a special handling code may instruct a shipper that climate-control is required. Then, at block 108 a rule is created by associating the received product code with the received special handling codes according to the received restriction type. The rule may be applied to shipments or air waybills to determine when special handling codes are required for a certain product type or to determine when special handling codes may not be used with certain product types.

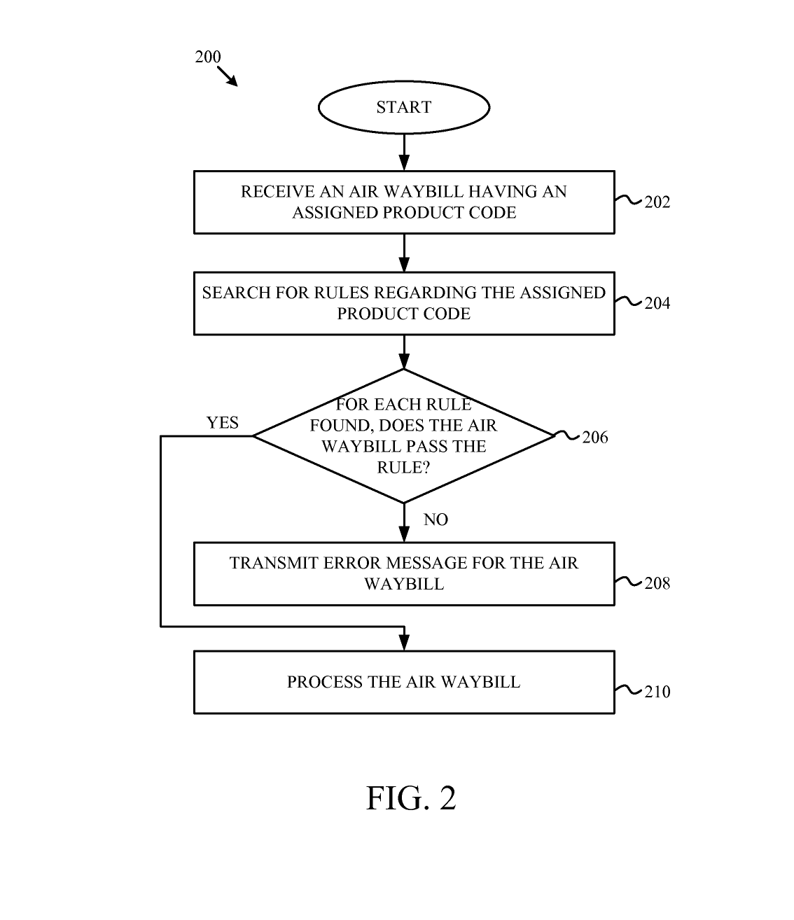

FIG. 2 is a flow chart illustrating a method of enforcing rules for product codes according to one embodiment of the disclosure. A method 200 begins at block 202 with receiving an air waybill having an assigned product code. The method 200 continues to block 204 with searching for rules regarding the assigned product code received at block 202. Each air waybill may have more than one product code, thus multiple rules may be located at block 204. Then, at block 206 the rules retrieved at block 204 are tested against the air waybill received at block 202. For example, if five rules are identified in block 204, two of which specify that a certain product code requires certain special handling codes and three of which specify that a certain product may not have certain special handling codes, then each of the five rules is applied to the air waybill.

For each rule, block 206 determines if the air waybill passes the rule. If any of the rules are not passed then the method 200 proceeds to block 208 to transmit an error message for the air waybill. According to one embodiment, special handling codes may be automatically applied to the air waybill if a rule at block 206 specifies a certain special handling code required for the product code of the air waybill received at block 202. According to another embodiment, special handling codes may be automatically deleted from the air waybill if a rule at block 206 specifies that certain special handling codes are prohibited for the product code of the air waybill received at block 202. If all of the rules are passed then the method 200 proceeds to block 210 to process the air waybill.

The rules for special handling codes may be enforced at any time during handling of an air waybill. For example, the rules may be enforced during transfer of CargoIMP messages (e.g., FWB, FFR, and FFM messages) related to the air waybill, examination of cargo portal services for the air waybill, examination of business-to-business services for the air waybill, and review of air waybill details on a computer terminal. Additionally, rules may be enforced during quoting and booking of an air waybill.

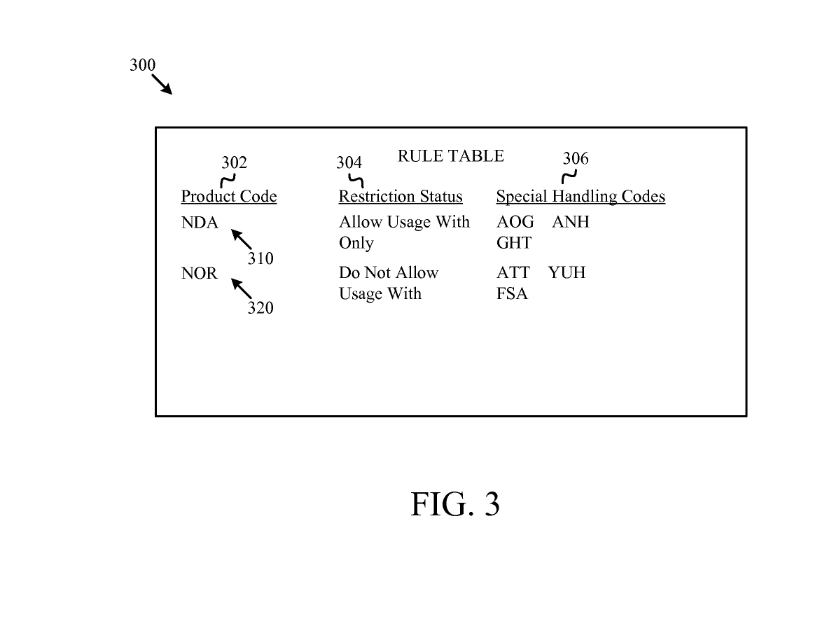

Rules tables may be displayed to a user or administrator for examination or modification. FIG. 3 is a block diagram illustrating rules for product codes according to one embodiment of the disclosure. A display 300 includes columns 302, 304, and 306, representing product code, restriction status, and associated special handling codes, respectively. A rule 310 in the display 300 indicates that the product code NDA may be used only with special handling codes AOG, ANH, and GHT. A rule 320 in the display 300 indicates that the product code NOR may not be used with special handling codes ATT, YUH, and FSA.

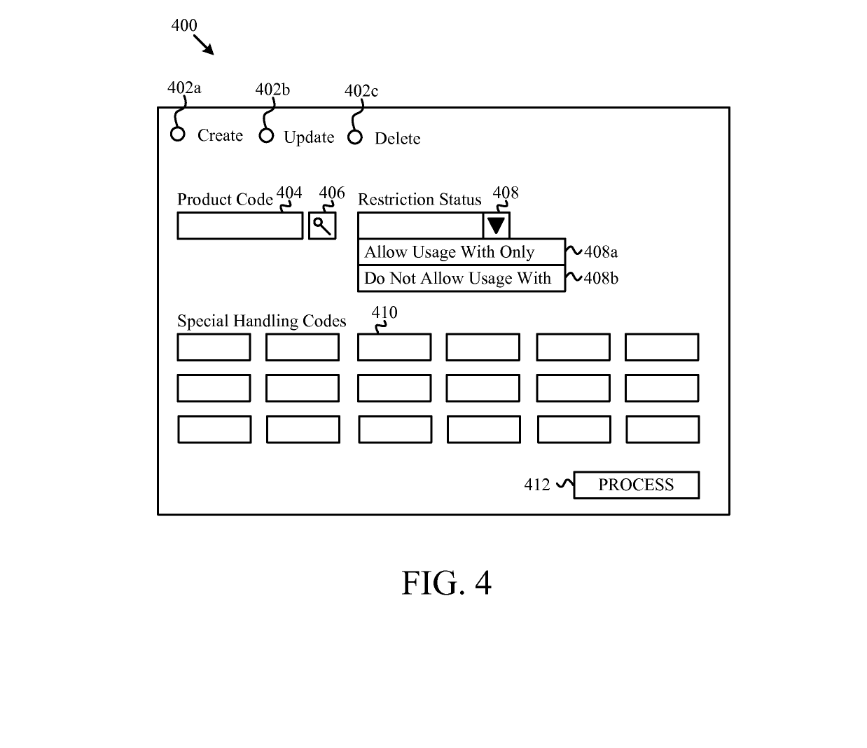

The display 300 may include a link to allow editing of one of the existing rules 310 and 320, include a link to allow deleting of one of the existing rules 310 and 320, and include a link to allow creation of new rules. FIG. 4 is a block diagram illustrating creating rules for product codes according to one embodiment of the disclosure. A display 400 for creating, updating, and/or deleting rules allows a user or administrator to access the rules table. A user or administrator may select one of a create option 402a, an update option 402b, or a delete option 402c. After selecting one of the options 402, the user or administrator may enter details in the remaining fields of the display 400 and select the process button 412 to create, update, or delete a rule in the rule table.

A product code text box 404 allows the selection of a product code. A product code may be typed in the product code text box 404 or the user or administrator may select the search button 406 to search for a particular product code. A restriction status text box 408 allows a user to select a restriction type. The text box 408 may have a drop-down list including items 408a and 408b for selection. Item 408a may specify a restriction status of “allow usage with only” certain special handling codes. Item 408b may specify a restriction status of “do not allow usage with” certain special handling codes. The special handling codes may be entered in text boxes 410. The special handling codes may include designations for dash (DSH), perishable (PER), live animals (AVI), valuable cargo (VAL), and flowers (FLW). More than one special handling code may be associated with any product code. Multiple rules may be specified for each product code.

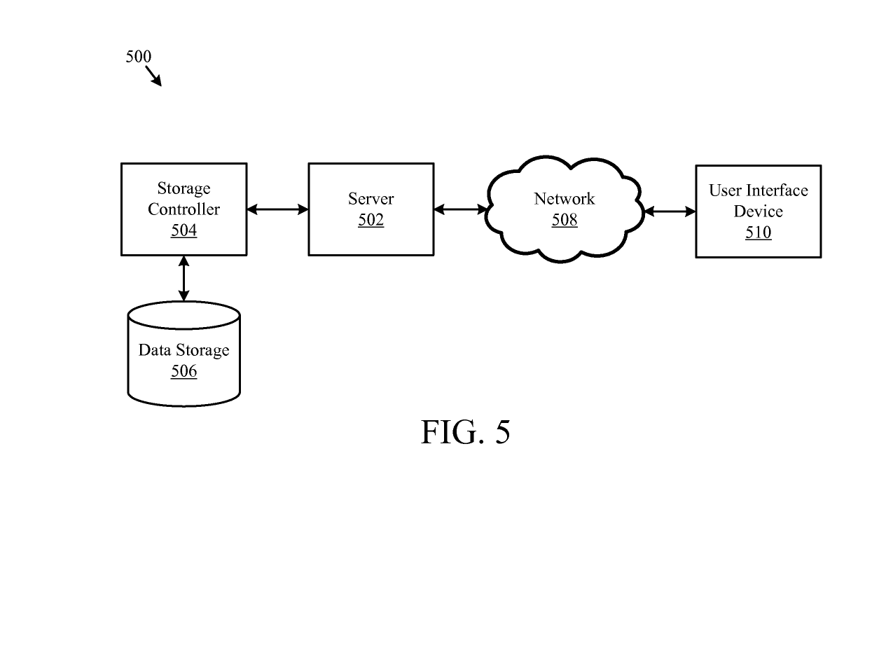

FIG. 5 illustrates one embodiment of a system 500 for an information system, such as a logistics management system (LMS). The system 500 may include a server 502, a data storage device 506, a network 508, and a user interface device 510. The server 502 may be a dedicated server or one server in a cloud computing system. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. In a further embodiment, the user interface device 510 may access the Internet or other wide area or local area network to access a web application or web service hosted by the server 502 and provide a user interface for enabling a user to enter or receive information.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS). In this embodiment, the user interface device 510 may be a computer executing a Java application making requests to a JBOSS server executing on a Linux server, which fulfills the requests by accessing a relational database management system (RDMS) on a mainframe server.

In one embodiment, the server 502 is configured to store databases, pages, tables, and/or records. Additionally, scripts on the server 502 may access data stored in the data storage device 506 via a storage area network (SAN) connection, a LAN, a data bus, or the like. The data storage device 506 may include a hard disk, including hard disks arranged in an redundant array of independent disks (RAID) array, a tape storage drive comprising a physical or virtual magnetic tape data storage device, an optical storage device, or the like. The data may be arranged in a database and accessible through structured query language (SQL) queries, or other data base query languages or operations.

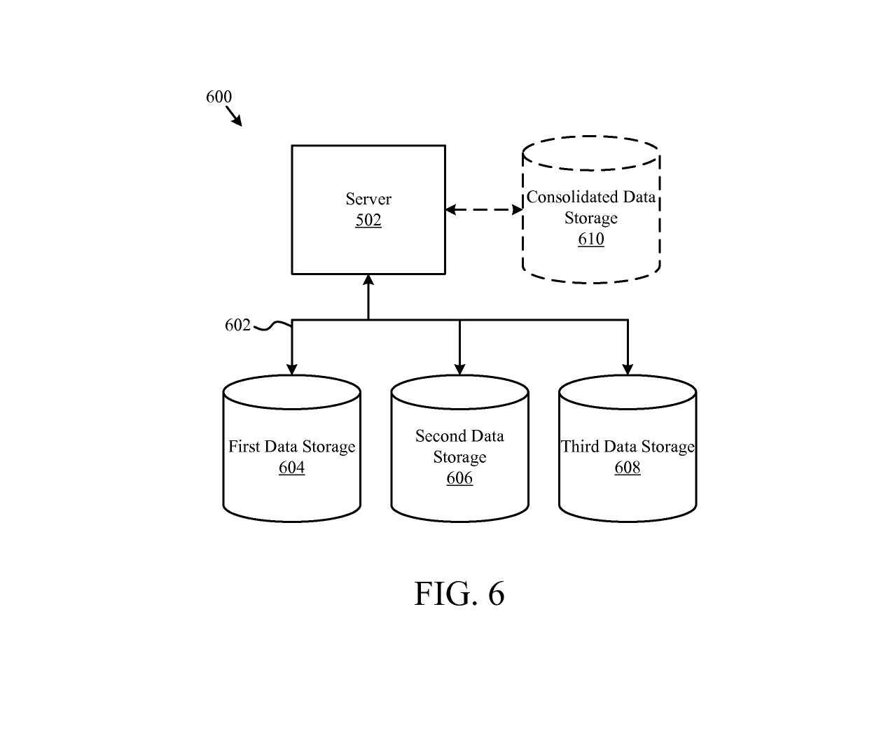

FIG. 6 illustrates one embodiment of a data management system 700 configured to store application parameters and documentation. In one embodiment, the data management system 600 may include the server 502. The server 502 may be coupled to a data-bus 602. In one embodiment, the data management system 600 may also include a first data storage device 604, a second data storage device 606, and/or a third data storage device 608. In further embodiments, the data management system 600 may include additional data storage devices (not shown). In such an embodiment, each data storage device 604, 606, and 608 may each host a separate database that may, in conjunction with the other databases, contain redundant data. Alternatively, a database may be spread across storage devices 604, 606, and 608 using database partitioning or some other mechanism. Alternatively, the storage devices 604, 606, and 608 may be arranged in a RAID configuration for storing a database or databases through may contain redundant data. Data may be stored in the storage devices 604, 606, 608, 610 in a database management system (DBMS), a relational database management system (RDMS), an object oriented database management system (OODMS), an Indexed Sequential Access Method (ISAM) database, a Multi Sequential Access Method (MSAM) database, a Conference on Data Systems Languages (CODASYL) database, or other database system.

In one embodiment, the server 502 may submit a query to select data from the storage devices 604 and 606. The server 502 may store consolidated data sets in a consolidated data storage device 610. In such an embodiment, the server 502 may refer back to the consolidated data storage device 610 to obtain a set of records. Alternatively, the server 502 may query each of the data storage devices 604, 606, and 608 independently or in a distributed query to obtain the set of data elements. In another alternative embodiment, multiple databases may be stored on a single consolidated data storage device 610.

In various embodiments, the server 502 may communicate with the data storage devices 604, 606, and 608 over the data-bus 602. The data-bus 602 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 502 may communicate indirectly with the data storage devices 604, 606, 608, and 610 by first communicating with a storage server (not shown) or the storage controller 504.

The server 502 may include modules for interfacing with the data storage devices 604, 606, 608, and 610, may include modules for interfacing with the network 508, and/or modules for interfacing with a user through the user interface device 510. In a further embodiment, the server 502 may host an engine, application plug-in, or application programming interface (API).

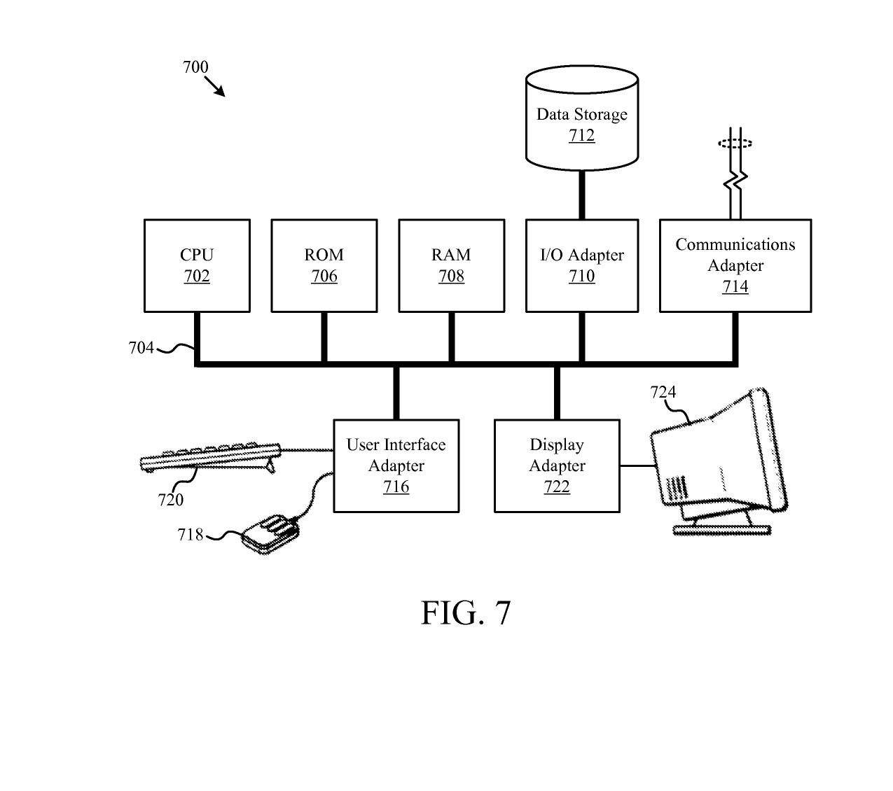

FIG. 7 illustrates a computer system 700 adapted according to certain embodiments of the server 502 and/or the user interface device 510. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the modules and operations as described herein. The CPU 702 may execute the various logical instructions according to the present embodiments.

The computer system 700 also may include random access memory (RAM) 708, which may be synchronous RAM (SRAM), dynamic RAM (DRAM), and/or synchronous dynamic RAM (SDRAM). The computer system 700 may utilize RAM 708 to store the various data structures used by a software application such as databases, tables, and/or records. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface associated with a software or web-based application on a display device 724, such as a monitor or touch screen.

The I/O adapter 710 may couple one or more storage devices 712, such as one or more of a hard drive, a flash drive, a compact disk (CD) drive, a floppy disk drive, and a tape drive, to the computer system 700. The communications adapter 714 may be adapted to couple the computer system 700 to the network 508, which may be one or more of a LAN, WAN, and/or the Internet. The communications adapter 714 may be adapted to couple the computer system 700 to a storage device 712. The user interface adapter 716 couples user input devices, such as a keyboard 720, a pointing device 718, and/or a touch screen (not shown) to the computer system 700. The display adapter 722 may be driven by the CPU 702 to control the display on the display device 724.

The applications of the present disclosure are not limited to the architecture of computer system 700. Rather the computer system 500 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a product code;
receiving a restriction type;
receiving at least one special handling code; and
associating the at least one special handling code with the product code according to the restriction type to create a rule.

2. The method of claim 1, in which the restriction type is at least one of allowing usage of the at least one special handling code with the product code and not allowing usage of the at least one special handling code with the product code.

3. The method of claim 1, further comprising storing the product code, the restriction type, and the at least one special handling code in a database.

4. The method of claim 3, further comprising:
receiving an air waybill having an assigned product code;
searching the database for rules matching the assigned product code; and
transmitting an error message when a rule applies to the assigned product code of the air waybill and the rule is not met.

5. The method of claim 3, further comprising:
receiving a request to update the rule; and
updating the rule in the database with at least one additional special handling code.

6. The method of claim 3, further comprising:
receiving a request to delete the rule; and
deleting the rule from the database.

7. The method of claim 3, further comprising:
receiving search criteria for locating a requested rule in the database; and
transmitting a list of rules matching the received search criteria.

8. A computer program product, comprising:
a non-transitory computer readable medium comprising:
code to receive a product code;
code to receive a restriction type;
code to receive at least one special handling code; and
code to associate the at least one special handling code with the product code according to the restriction type to create a rule.

9. The computer program product of claim 8, in which the restriction type is at least one of allowing usage of the at least one special handling code with the product code and not allowing usage of the at least one special handling code with the product code.

10. The computer program product of claim 8, in which the medium further comprises code to store the product code, the restriction type, and the at least one special handling code in a database.

11. The computer program product of claim 10, in which the medium further comprises:
code to receive an air waybill having an assigned product code;
code to search the database for rules matching the assigned product code; and
code to transmit an error message when a rule applies to the assigned product code of the air waybill and the rule is not met.

12. The computer program product of claim 11, in which the medium further comprises:
code to receive a request to update the rule; and
code to update the rule in the database with at least one additional special handling code.

13. The computer program product of claim 8, in which the medium further comprises:
code to receive search criteria for locating a requested rule in the database; and
code to transmit a list of rules matching the received search criteria.

14. The computer program product of claim 8, in which the medium further comprises:
code to receive a request to delete the rule; and
code to delete the rule from the database.

15. A system, comprising:
a memory; and
at least one processor coupled to the memory, in which the at least one processor is configured:
to receive a product code;
to receive a restriction type;
to receive at least one special handling code; and
to associate the at least one special handling code with the product code according to the restriction type to create a rule.

16. The system of claim 15, in which the restriction type is at least one of allowing usage of the at least one special handling code with the product code and not allowing usage of the at least one special handling code with the product code.

17. The system of claim 15, in which the at least one processor is further configured to store the product code, the restriction type, and the at least one special handling code in a database.

18. The system of claim 17, in which the at least one processor is further configured:
to receive an air waybill having an assigned product code;
to search the database for rules matching the assigned product code; and
to transmit an error message when a rule applies to the assigned product code of the air waybill and the rule is not met.

19. The system of claim 17, in which the at least one processor is further configured:
to receive a request to update the rule; and
to update the rule in the database with at least one additional special handling code.

20. The system of claim 17, in which the at least one processor is further configured:
to receive a request to delete the rule; and
to delete the rule from the database.
